(19) United States
(12) Patent Application Publication
(10) Pub. No.: US 2026/0093562 A1
(43) Pub. Date: Apr. 2, 2026

(54) DISTRIBUTED ORCHESTRATION ARCHITECTURES, AND RELATED SYSTEMS AND METHODS

(71) Applicant: LiveView Technologies, LLC, American Fork, UT (US)

(72) Inventors: Roy W. Hayward, American Fork, UT (US); Steven R. Lindsey, American Fork, UT (US)

(21) Appl. No.: 19/263,637

(22) Filed: Jul. 9, 2025

Related U.S. Application Data
(60) Provisional application No. 63/700,258, filed on Sep. 27, 2024.

(51) Int. Cl. G06F 9/54; G06F 9/48

(52) U.S. Cl. CPC G06F 9/542; G06F 9/4881

(57) ABSTRACT

Various embodiments relate to event-driven architectures. An event-driven architecture may include an event bus and an orchestrator communicatively coupled to the event bus. The event-driven architecture may also include a number of components communicatively coupled to the event bus. A first component of the number of components is configured to perform a first workflow in response to a first event. Further, the orchestrator is configured to perform a second workflow in response to a second, different event. Associated methods and systems are also disclosed.

### PRIORITY CLAIM

This application claims the benefit of the filing date of U.S. Provisional Patent Application Ser. No. 63/700,258 filed Sep. 27, 2024, for “DISTRIBUTED ORCHESTRATION ARCHITECTURES, AND RELATED SYSTEMS AND METHODS,” the disclosure of which is hereby incorporated herein in its entirety by this reference.

### TECHNICAL FIELD

This disclosure relates generally to event-driven architectures and, more specifically, to event-driven architectures including both sophisticated and unsophisticated components, and to related systems and methods.

### BACKGROUND

Entities are increasingly relying on distributed systems to manage complex operations and provide seamless user experiences. However, traditional monolithic architectures often struggle to meet the scalability and flexibility demands of modern applications.

Event-driven architectures (EDAs) are a way of designing and building systems that are based on the exchange of events, which may occur within a system or an environment. Events, which may be generated by user interactions, sensors, and other software components, are notifications of some change in state or data, and events are typically published by one component and consumed by another component in real time. Event-driven architectures are commonly used in, for example only, IoT, real-time analytics, and microservices.

### BRIEF SUMMARY

At least one embodiment of the disclosure includes a system including an event-driven architecture. The system includes an event bus, and an orchestrator communicatively coupled to the event bus. The system further includes a number of components communicatively coupled to the event bus, wherein, in response to a first event, a first component of the number of components is configured to perform a first workflow of a number of workflows. Moreover, the orchestrator is configured to: distribute the first workflow to the first component; and perform, in response to a second event, a second workflow of the number of workflows.

Another embodiment includes a system having an event bus and a number of components communicatively coupled to the event bus. A first component of the number of the components is configured to perform a first workflow in response to a first event. Further, the system includes an orchestrator communicatively coupled to the event bus and configured to perform a second, different workflow in response to a second, different event.

Another embodiment includes a method of operating an event-driven architecture. The method includes receiving, at a bus of the event-driven architecture, a first message associated with an event. Further, the method includes, responsive to determining that a service of a number of services does not include a workflow for the event: generating, via an orchestrator, a second message; publishing the second message to the bus; and receiving, via the service, the second message. The method also includes receiving, via the service, the first message responsive to determining that the service includes the workflow for the event. In addition, the method includes performing an action via the service.

In yet another embodiment, an event-driven architecture includes an event bus, and an orchestrator communicatively coupled to the event bus. The event-driven architecture further includes a number of components communicatively coupled to the event bus, wherein a first component of the number of components is configured to perform a first workflow. Further, the orchestrator is configured to perform a second workflow.

According to another embodiment, a method of operating an event-driven architecture includes receiving a number of workflows at an orchestrator of the event-driven architecture. The method also includes determining, for each of a number of components of the event-driven architecture, whether the component is a sophisticated component or an unsophisticated component. In addition, the method includes sending a first workflow of the number of workflows to a first, sophisticated component of the number of components. Moreover, the method includes configuring the orchestrator to perform a second workflow of the number of workflows, wherein the event-driven architecture does not include a sophisticated component to perform the second workflow.

### BRIEF DESCRIPTION OF THE DRAWINGS

FIG. 1 depicts an example system including an orchestrator, a bus, and a number of components.

FIG. 2 is a flowchart illustrating an example method associated with an event-driven architecture.

FIG. 3 depicts an example system including an architecture having an orchestrator, a bus, and a number of components, according to various embodiments of the disclosure.

FIGS. 4A and 4B depict a flowchart illustrating another example method associated with an event-driven architecture.

FIG. 5 is a flowchart illustrating yet another example method associated with an event-driven architecture.

FIG. 6 depicts an example system including a mobile unit, in accordance with one or more embodiments of the disclosure.

FIG. 7 illustrates another example system including a mobile unit, in accordance with various embodiments of the disclosure.

FIG. 8 is a flowchart illustrating an example method of operating an event-driven architecture, according to various embodiments of the disclosure.

FIG. 9 is a flowchart illustrating another example method of operating an event-driven architecture, according to various embodiments of the disclosure.

### DETAILED DESCRIPTION

Referring in general to the accompanying drawings, various embodiments of the present invention are illustrated to show example embodiments related to distributed orchestration architectures. It should be understood that the drawings presented are not meant to be illustrative of actual views of any particular portion of an actual circuit, device, system, or structure, but are merely representations which are employed to more clearly depict various embodiments of the disclosure.

The following provides a more detailed description of the present invention and various representative embodiments thereof. In this description, functions may be shown in block diagram form in order not to obscure the present invention in unnecessary detail. Additionally, block definitions and partitioning of logic between various blocks is exemplary of a specific implementation. It will be readily apparent to one of ordinary skill in the art that the present invention may be practiced by numerous other partitioning solutions. For the most part, details concerning timing considerations and the like have been omitted where such details are not necessary to obtain a complete understanding of the present invention and are within the abilities of persons of ordinary skill in the relevant art.

As noted above, an event-driven architecture may include a number of services (also referred to herein as “components”), wherein each service may produce and/or consume an event, which may be, for example, a change in state or data.

Although various embodiments are described herein with reference to security and/or surveillance systems and/or mobile security and/or mobile surveillance units, the present disclosure is not so limited, and the embodiments may be generally applicable to any system and/or device that may or may not include security and/or surveillance systems and/or units. Further, although some embodiments are disclosed with reference to a mobile unit, the disclosure is not so limited, and a person having ordinary skill will understand that various embodiments may be applicable to stationary units (e.g., stationary security/surveillance devices), such as a unit coupled to a stationary pole (e.g., a light pole), a structure (e.g., of a business or a residence), a tree, etc. Further, embodiments of the disclosure may be applicable to non-security/surveillance cases. For example, various embodiments may be implemented in form factors that may be installed in server/network rooms, on a server rack, and/or a desktop unit, without limitation. A person of ordinary skill will understand that various embodiments may be implemented in any suitable event-driven architecture environment.

Embodiments of the disclosure will now be explained with reference to the accompanying drawings.

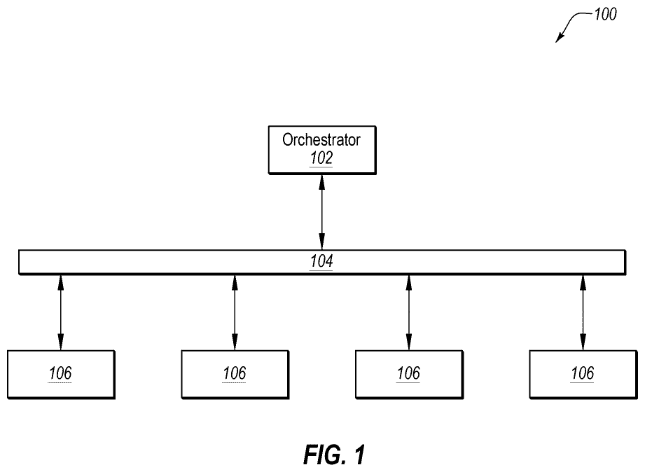

FIG. 1 illustrates an example system 100, which may include an event-driven architecture. System 100 includes an orchestrator 102 (also referred to herein as a “orchestration engine”), a bus (e.g., an event or message bus) 104, and a number of components (also referred to herein as “integrated components,” “devices,” “component services,” “service components,” “services,” or some variation thereof) 106. It is noted that services may include software services and/or non-software services.

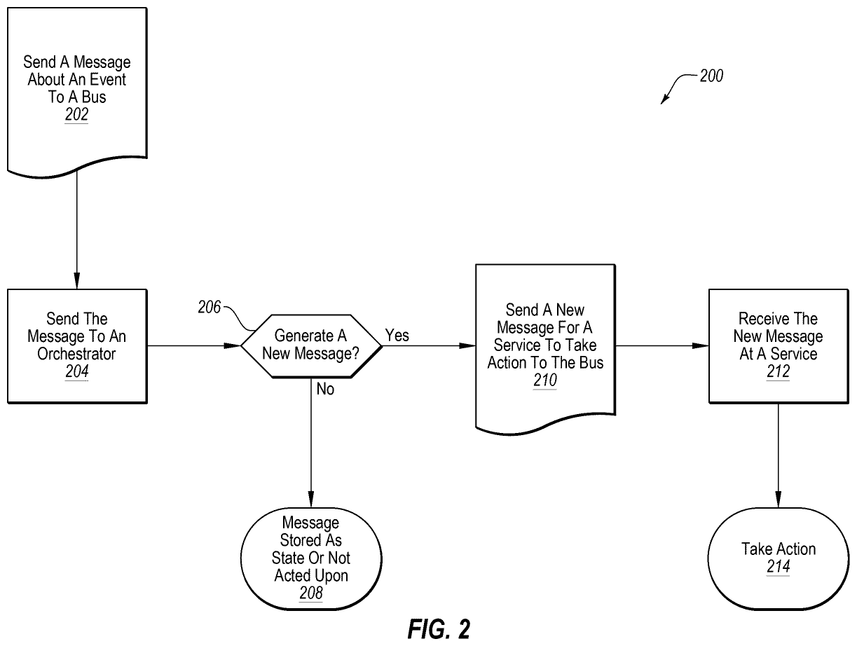

FIG. 2 is a flowchart of a method 200 associated with an event-driven architecture. Method 200 may begin at block 202, wherein a message concerning an event (e.g., a detected event) is published to a bus (e.g., bus 104 of FIG. 1). At block 204, the message is sent to an orchestrator (e.g., an orchestration service, such as orchestrator 102 of FIG. 1), and at block 206, it is determined whether the orchestrator should generate a new message. For example, if the message should be stored as a state and/or if the message is not to be acted upon, method 200 may proceed from block 206 to block 208. Otherwise, method 200 may proceed from block 206 to block 210 wherein the new message (i.e., for a component/service to perform an action) is generated and published to the bus, and method 200 proceeds to block 212. At block 212, the new message is received by a service (e.g., component 106 of FIG. 1), and, at block 214, the service takes action responsive to receipt of the new message.

As will be appreciated by a person having ordinary skill in the art, a “workflow” is a representation of a sequence of tasks (e.g., an automation recipe) that can be used to represent any process (e.g., in an event-driven architecture). Stated another way, a workflow may include an orchestrated and repeatable pattern of activity (e.g., enabled by the systematic organization of resources into processes) that transform materials, perform acts, provide services, and/or processes information.

A purely orchestrated architecture requires a single orchestration entity (e.g., orchestrator 102) to coordinate the logic for each integrated component (e.g., each component 106) of the architecture. In other words, each integrated component (e.g., each component 106) is unsophisticated, and an orchestrator (e.g., orchestrator 102) is tasked with performing all associated workflows. A purely orchestrated architecture may suffer from latency and/or single-point-of-failure problems.

In contrast, in a purely choreographed architecture, logic is included at each integrated component of the architecture (e.g., each component 106 (see FIG. 1) is sophisticated) and each integrated component must perform its own workflow. In this example, if an unsophisticated component is included (e.g., added to the architecture), middleware is required to be added to the architecture. Further, a purely choreographed architecture is difficult to maintain, and as will be appreciated, any change to one component in a purely choreographed architecture requires that every other component that is dependent on or subscribes to the one component be retested and possibly updated.

Various embodiments disclosed herein relate to distributed orchestration architectures, and more specifically to distributed orchestration of services (also referred to as “components”) within event-driven architectures. Various embodiments may address (e.g., solve) the difficulty of a topology comprised of both sophisticated and unsophisticated technologies in an event-driven architecture. For example, various embodiments may provide a single repository and interface for logic (e.g., business logic) and workflow generation for a topology. Further, an orchestrator (e.g., an orchestration engine), which may be aware of the sophistication (or lack thereof) of the integrated components of an architecture, may push proper workflows and logic to each sophisticated component such that each sophisticated component may operate the orchestration (e.g., its workflow) on its own. Further, the orchestrator may be configured to perform workflows for any unsophisticated components within the architecture. According to at least some embodiments, to a workflow interface, each workflow appears to be performed by the orchestrator, although some workflows may be actually performed by an integrated component (i.e., a sophisticated component). This may increase reliability and decrease latency for an event-driven architecture.

According to various embodiments, in an event-driven architecture (e.g., an event driven integrated architecture), one or more devices may receive, send, and/or process events according to logic (e.g., business logic) supplied by a user and thus these workflow devices may work as an orchestrating tool for events in the architecture. Integrated components (also referred to herein as “integrated services”), which may send and/or receive events and commands within the event-driven architecture, may be designated by their ability to perform workflow operations independent of an orchestrator.

For example, an orchestrator may send a workflow as an object, recipe, or other data to a component service (i.e., a sophisticated component service) to allow the component service to perform the workflow (i.e., without or before sending an event to the orchestrator). Further, according to some embodiments, when a user updates or deletes a workflow, an update of the workflow may be sent (e.g., from an orchestrator) to the associated component service (or the workflow may be deleted). Moreover, users may be able to interact with workflow tools without knowing or needing to know if a device performing the workflow is the orchestrator or a component service. Moreover, a user may be able to interact with logic in a single place and interface. This may solve choreographed architecture challenges of workflow visualization and understanding.

Various embodiments may reduce latency and decrease, or possibly eliminate, single point of failure issues with conventional orchestration solutions. More specifically, latency in operations of a component service (i.e., that may perform a workflow) may be reduced (e.g., because communication between the component service and an orchestrator (i.e., before performing the workflow) may be avoided). Further, single-point-of-failure dependencies of a central orchestrator may be reduced, or possibly eliminated (e.g., because of workflows being published to the component services). These workflows may run independently, and messages pushed to the orchestrator for synchronization and notification purposes may remain queued (e.g., until such time that the orchestrator comes back online). Moreover, changes in the component services by either upgrading the component services or replacing the component services with component services that add the ability to perform the workflow actions, or that remove the ability, may not change the workflow and business logic. An orchestrator may either publish a workflow to a component (i.e., a component with the new ability to perform the workflow) or assume the responsibility for that workflow (e.g., when a service component can no longer perform the workflow).

In contrast to conventional solutions, various embodiments may provide highly scalable solutions that may manage large volumes of events and distribute workloads across multiple services. Further, disclosed embodiments may be highly resilient and may tolerate failures and continue to operate despite partial system failures. Moreover, disclosed embodiments provide for a highly decoupled solution wherein each service may operate independently and without knowledge of other services.

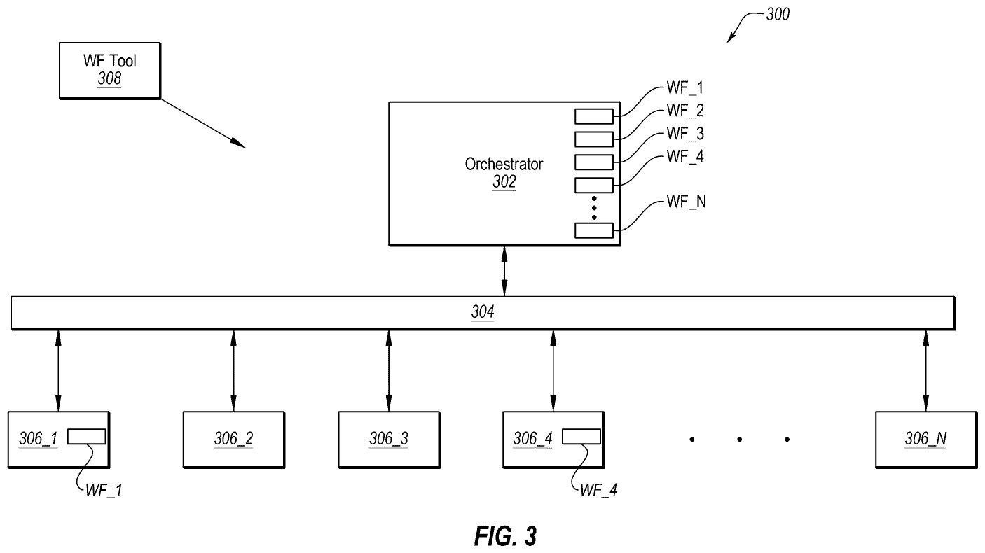

FIG. 3 illustrates another example system 300, according to various embodiments of the disclosure. As an example, system 300 may be part of, may include, and/or may be referred to as, a “distributed orchestration architecture.” System 300, which may include an event-driven architecture, includes an orchestrator 302, a bus (e.g., an event or message bus) 304, and a number of components (also referred to herein as “integrated components,” “devices,” “component services,” “service components,” “services,” or some variation thereof) 306. In contrast to conventional systems, system 300 may include both sophisticated components and unsophisticated components (i.e., within the same system and/or architecture). More specifically, for example, one or more components of system 300 may be configured to perform processing (i.e., for a workflow) and at least one or more other components of system 300 may not be configured to perform processing (i.e., for a workflow).

Each component 306 may include any suitable device, such as a control device, an output device, a sensor device, an input device, and/or any combination thereof, without limitation. As will be appreciated, each component 306 may publish to bus 304 and/or subscribe to events (i.e., in an associated channel, topic, category, etc.). Further, in some embodiments, orchestrator 302 may subscribe to all events. In other words, in at least some embodiments, orchestrator 302 may be aware of everything published to bus 304.

System 300 further includes a workflow tool (e.g., a workflow generator) 308 and a number of workflows WF. Workflow tool 308 may be communicatively coupled to orchestrator 302, bus 304, and/or one or more of components 306. For example, a user (e.g., an operator, such as a customer success manager, an engineer, or any other operator or user) may provide information to workflow tool 308 for generating a workflow. Further, depending on the workflow, orchestrator 302 may publish a generated workflow (e.g., on a channel separate from a channel for commands and/or events) to bus 304 instructing a component (e.g., one of component 306) to implement the workflow. In this example, after the component receives the workflow and subscribes to the associated event, orchestrator 302 may unsubscribe to the event. However, it is noted that orchestrator 302 may maintain a copy of the workflow (WF). In the event a new (e.g., updated) version of a workflow is generated (e.g., via a user and/or workflow tool 308), orchestrator 302 may identify the workflow as a distributed workflow (i.e., that workflow is being implemented by a sophisticated (smart) component) and publish the new version of the workflow to the appropriate component. In the example shown in FIG. 3, component 306_1 and component 306_4 are sophisticated components (i.e., components 306_1 and 306_4 include a WF), and component 306_2, component 306_3, and component 306_N are unsophisticated components (i.e., components 306_2, 306_3, and 306_N do not include a WF).

For example, if a new (e.g., updated) version of a workflow is generated, orchestrator 302 may determine whether or not the associated component is capable of performing the workflow. If orchestrator 302 determines that the component is not sufficiently sophisticated to perform the workflow, orchestrator 302 may assume the responsibility to perform the workflow. If orchestrator 302 determines that the component is sufficiently sophisticated to perform the workflow, orchestrator 302 may publish the new workflow to the component.

In some examples, system 300 may include and/or may have access to a user managed registry that includes information about associated components and what the components are able to do. For example, the information could be as simple as a device ID and a “yes” or “no” indicating whether a component is sophisticated. As another example, the information may include a set of flags indicating the types of workflows that the component can manage. In some examples, a sophisticated component may publish (e.g., over bus 304) a message including the same information that may be in the registry. This information could be stored (e.g., in a registry or cache) and updated whenever component capabilities change (e.g., due to firmware or hardware upgrades).

In some examples, system 300 may include one or more REST APIs (not shown in FIG. 3) (e.g., if an associated component is unable to publish a message and/or an event), as will be appreciated by a person having ordinary skill in the art.

In one non-limiting, simplified example wherein system 300 is implemented within a building (e.g., of a business), component 306_1 may include an access control device, component 306_2 may include a lighting control device, component 306_3 may include a coffee maker, and component 306_4 may include a temperature control (e.g., HVAC) device. In this example, if a human were to enter a room, component 306_1 (i.e., the access control device in this example) may publish an event (e.g., “someone entered the room”) to bus 304. Further, in this example because component 306_2 (i.e., the lighting control device in this example) is unsophisticated and does not include a workflow, orchestrator 302 may perform the workflow (i.e., the workflow for the “someone entered the room” event) and send (e.g., publish) a command to bus 304 for component 306_2 to take action (e.g., turn on light). If component 306_2 was sophisticated and included a workflow, component 306_2 may have taken action (e.g., turn on light) in response to the event published by component 306_1 (i.e., rather than the command published by orchestrator 302). Further, because component 306_3 is unsophisticated, orchestrator 302 may, in response to the event published by component 306_1, publish a command to bus 304 for component 306_3 to take action (e.g., start making coffee) (e.g., based on a time of day being such that coffee should be made). Continuing with this example, in response to the event published by component 306_1, component 306_4, which is a sophisticated component in this example, may adjust the temperature setting of the building. More specifically, component 306_4 may, based on its workflow, adjust one or more temperature settings of the building (e.g., based on various factors, such as season, time of day, day of the week, etc.).

As another non-limiting example wherein system 300 is implemented within a surveillance/security application, component 306_1 may include a detection sensor, such as a camera, component 306_2 may include a lighting control device and/or one or more lighting devices, component 306_3 may include an output device (e.g., including a speaker), and component 306_4 may include an alert generator. In this example wherein a surveillance/security unit (e.g., a mobile unit) is positioned in a parking lot, if a vehicle enters the parking lot after a certain time (e.g., between midnight and 6:00 AM), component 306_1 (i.e., the detection sensor in this example) may publish an event (e.g., “vehicle detected”) to bus 304. Further, in this example, because component 306_2 (i.e., the lighting control device in this example) is unsophisticated and does not include a workflow, orchestrator 302 may perform the workflow (i.e., the workflow for the “vehicle detected” event) and publish a command to bus 304 for component 306_2 to take action (e.g., turn on light). Like the example above, if component 306_2 was sophisticated and included a workflow, component 306_2 may have taken action (e.g., turn on light) in response to the event published by component 306_1 (i.e., rather than the command published by orchestrator 302). Further, because component 306_3 is unsophisticated, orchestrator 302 may, in response to the event published by component 306_1, publish a command to bus 304 for component 306_3 to take action (e.g., turn on siren or other audible alert). Continuing with this example, in response to the event published by component 306_1, component 306_4, which is a sophisticated component in this example, may, based on its workflow, generate one or more alerts and/or send an alert to personnel (e.g., security or other user). More specifically, component 306_4 may, based on its workflow, generate and send an alert message (e.g., text, email, phone call, etc.) to personnel, and/or issue a verbal alert (e.g., via component 306_3).

It will be appreciated that system 300 may include additional and/or fewer devices. Further, the examples disclosed herein are provided as examples only, and a person having ordinary skill in the art would appreciate that a system (e.g., system 300) may be implemented in numerous other examples scenarios and/or configurations.

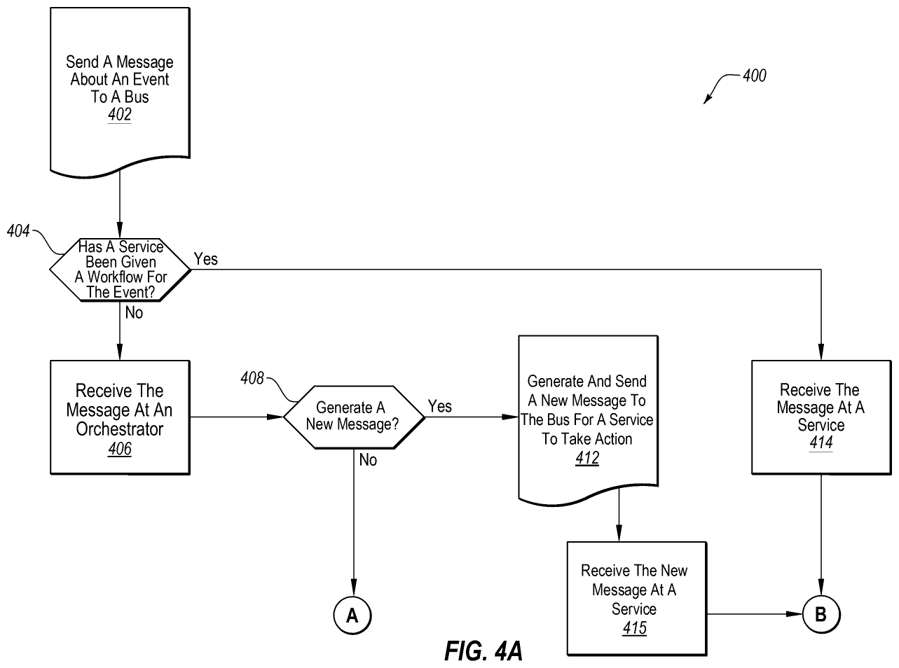

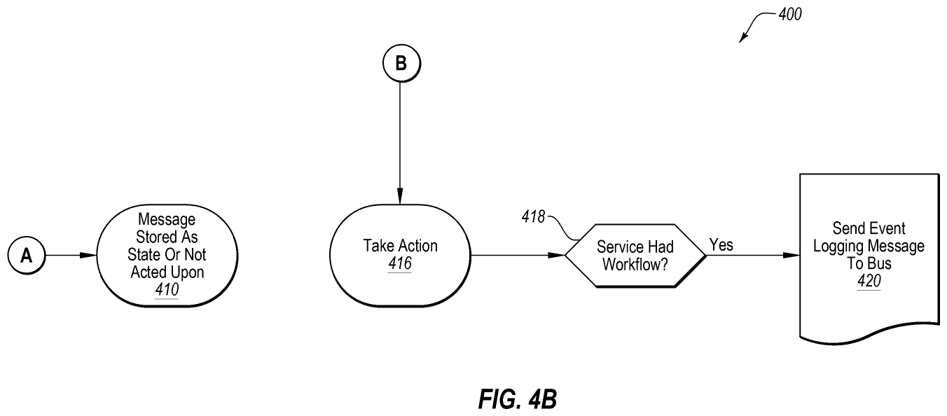

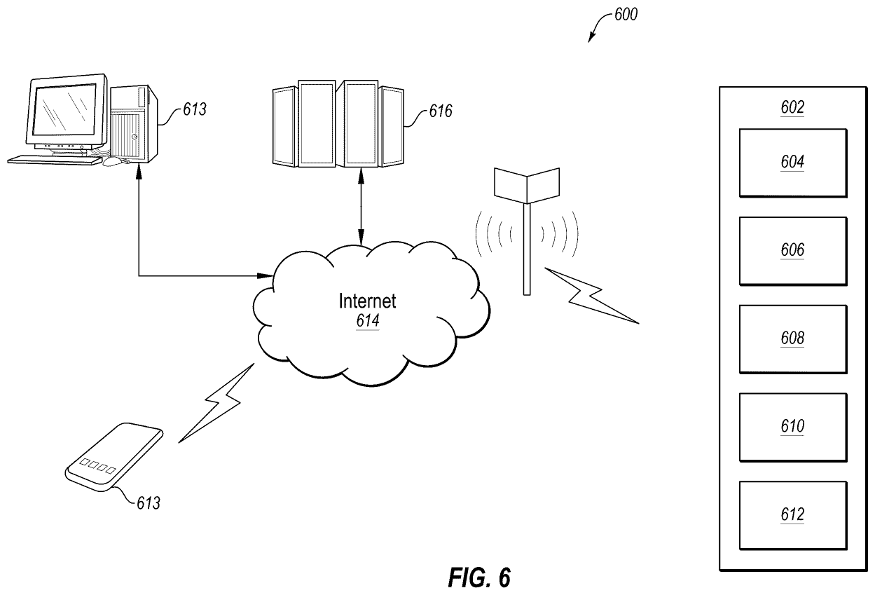

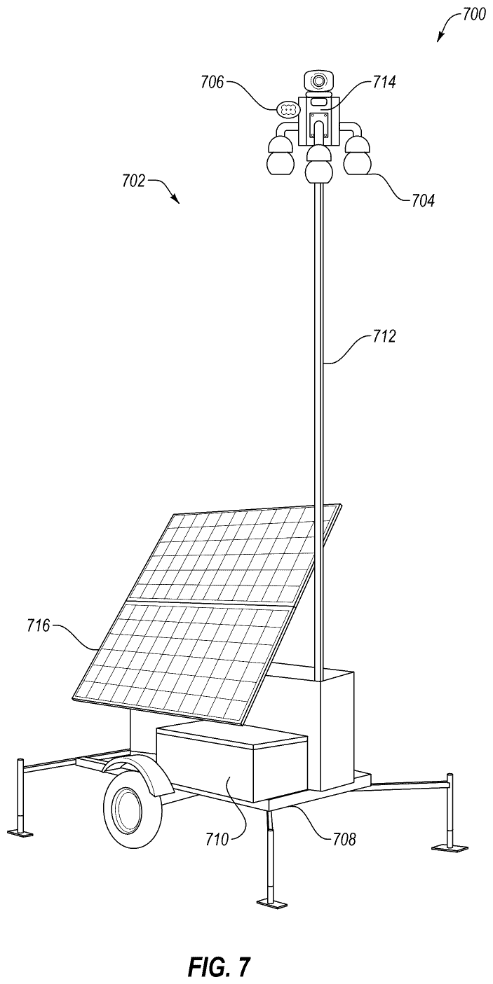

FIGS. 4A and 4B depict a flowchart of an example method 400 of operating an event-driven architecture. Method 400 may be arranged in accordance with at least one embodiment described in the disclosure. Method 400 may be performed, in some embodiments, by a device or system, such as system 300 (see FIG. 3), a system 600 (see FIG. 6), a system 700 (see FIG. 7), or another device or system. Although illustrated as discrete blocks, various blocks may be divided into additional blocks, combined into fewer blocks, or eliminated, depending on the desired implementation.

Method 400 may begin at block 402, wherein a first message regarding an event is published (e.g., sent) to a bus, and method 400 may proceed to block 404. For example, in response to the event (e.g., detected by a component), the first message is provided to an event bus (also referred to herein as a “message bus”) (e.g., bus 304 of FIG. 3) (e.g., by the component) of an event-driven architecture.

At block 404, it may be determined whether a service (e.g., a component of the event-driven architecture) has been provided a workflow for the event. In other words, it may be determined if a component includes, and is configured to perform (implement), the workflow. If it is determined that the workflow associated with the event is not assigned to a service, method 400 may proceed to block 406, where the message may be received by an orchestrator, and thereafter method 400 may proceed to block 408. For example, with reference to FIG. 3, if a workflow (WF) for the event is not assigned to a service (e.g., a component 306), the first message may be received by orchestrator 302, which may include, and may be configured to perform, the workflow for the event. If it is determined that the workflow associated with the event is assigned to a service, method 400 may proceed from block 404 to block 414.

At block 408, it may be determined whether the orchestrator may (and should) generate a second message (i.e., a new message). For example, if the first message is to be stored as a state and/or the first message is not to be acted upon, method 400 may proceed from block 408 to block 410, where the first message is stored and/or is not acted upon. Otherwise, method 400 may proceed from block 408 to block 412, where a second (new) message (i.e., for a service (e.g., component 306 of FIG. 3) to take action) is generated (e.g., via the orchestrator or another device) and published (e.g., sent) to the bus (e.g., bus 304 of FIG. 3). For example, the orchestrator may have performed a workflow for the event (i.e., the event identified in block 402) prior to the second message being sent to the bus. More specifically, for example, in response to the event (e.g., detection of a vehicle within a parking lot at a certain time), the orchestrator may take action (e.g., determine appropriate response to the event based on the workflow) and publish (e.g., send) a command (e.g., the second message) to the bus for a service (e.g., lighting control) to receive and take further action (e.g., turn on a spotlight).

It is noted that, in some examples, in response to a received message (e.g., at block 406), “yes” may be answered one or more times at block 408, and in these examples, one or more messages (e.g., for one or more services/components) may be generated at block 412. As a more specific example, in response to an orchestrator receiving a door sensor open message, the orchestrator may send a message to turn on lights, a message to play sounds, a message to send a notification (e.g., to a dashboard), and/or other actions. As will be appreciated, these messages may be sent to a single component (e.g., the single component receives all the message) or one or more of these messages may be sent to one component and one or more other of these messages may be sent to at least one other component.

At block 415, the second message is received at a service, and method 400 proceeds to block 416, where the service acts upon the received message. At block 414, the message (i.e., the first message) is received by a service, and method 400 proceeds to block 416, where the service acts upon the received message. It is noted that the service of block 414 may not be the same service noted in block 415.

In one example wherein the services include the workflow (i.e., the service is sophisticated), the service, upon receipt of the first message, may perform the workflow to determine a necessary action, and thereafter perform the action (i.e., at block 416) (e.g., determine a spotlight should be turned on and, thereafter, turn the spotlight on). In another example wherein the service is unsophisticated, the orchestrator, after performing the workflow (i.e., to determine what action is necessary), may publish the second message (e.g., a command) to the bus for the service to receive and take action (i.e., at block 416) (i.e., turn the spotlight on).

At block 418, if it was determined that a service included the workflow (i.e., the service is sophisticated), an event logging message may be published (e.g., from the service) to the bus (e.g., bus 304 of FIG. 3) at block 420.

Modifications, additions, or omissions may be made to method 400 without departing from the scope of the present disclosure. For example, the operations of method 400 may be implemented in differing order. Furthermore, the outlined operations and actions are only provided as examples, and some of the operations and actions may be optional, combined into fewer operations and actions, or expanded into additional operations and actions without detracting from the essence of the disclosed embodiment. For example, method 400 may include determining, for each service of a number of services of the event-driven architecture, whether a service is a sophisticated service or an unsophisticated service. In addition, for example, method 400 may include subscribing, via the orchestrator, to one or more events associated with each service of the number of services determined to be unsophisticated.

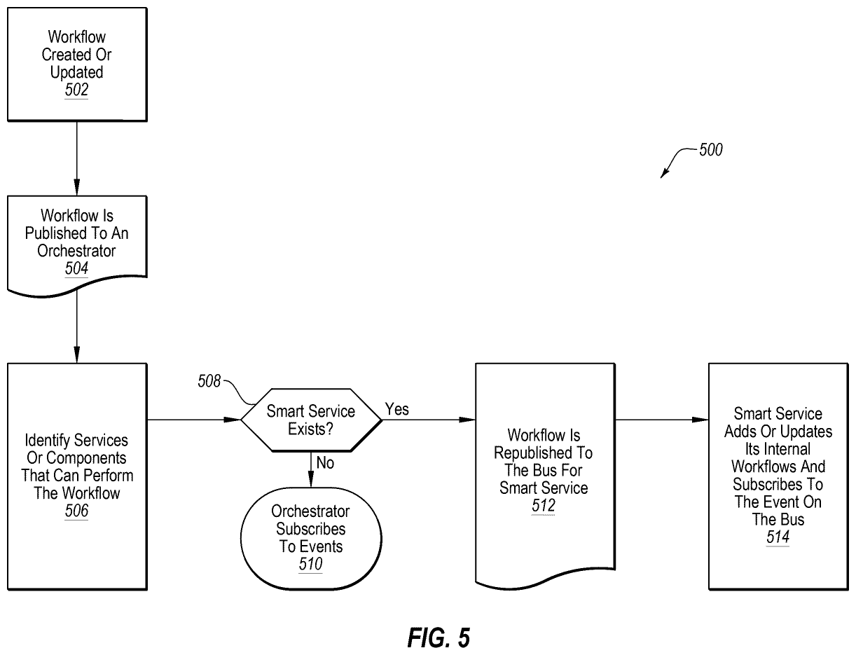

FIG. 5 is a flowchart of an example method 500 of publishing a workflow.

Method 500 may be arranged in accordance with at least one embodiment described in the disclosure. Method 500 may be performed, in some embodiments, by a device or system, such as system 300 (see FIG. 3), system 600 (see FIG. 6), system 700 (see FIG. 7), or another device or system. Although illustrated as discrete blocks, various blocks may be divided into additional blocks, combined into fewer blocks, or eliminated, depending on the desired implementation.

Method 500 may begin at block 502, wherein a workflow may be created or updated, and method 500 may proceed to block 504. For example, the workflow (e.g., WF in FIG. 3) may be created or updated via workflow tool 308 of FIG. 3.

At block 504, the workflow may be published, and method 500 may proceed to block 506. For example, the workflow may be published to an orchestrator (e.g., orchestrator 302 of FIG. 3).

At block 506, it may be determined which service, if any, may perform the workflow, and method 500 may proceed to block 508. For example, orchestrator 302 (see FIG. 3) may determine which service (e.g., which component 306 of FIG. 3), if any, may perform the workflow.

At block 508, it may be determined whether the identified service (i.e., identified at block 506) is a sophisticated service. For example, orchestrator 302 (see FIG. 3) and/or another device may determine whether the identified service is a sophisticated service (also referred to herein as a “smart service”). It is noted that a sophisticated service may be configured to perform a workflow (i.e., for an event), and thus the service may be assigned the workflow (i.e., for the event).

If it is determined the identified service is not a sophisticated service, method 500 may proceed to block 510, where the orchestrator (e.g., orchestrator 302) subscribes to associated events (i.e., events associated with the workflow). If it is determined that the identified service is a sophisticated service, method 500 may proceed to block 512.

At block 512, the workflow is republished to the bus, and method 500 may proceed to block 514, where the identified service may update its internal workflow (e.g., such that the identified service performs the workflow) and possibly subscribe to the event on the bus.

Modifications, additions, or omissions may be made to method 500 without departing from the scope of the present disclosure. For example, the operations of method 500 may be implemented in differing order. Furthermore, the outlined operations and actions are only provided as examples, and some of the operations and actions may be optional, combined into fewer operations and actions, or expanded into additional operations and actions without detracting from the essence of the disclosed embodiment.

FIG. 6 illustrates a system 600, according to one or more embodiments of the disclosure. System 600, which may include a security and/or surveillance system, includes a unit 602, which may also be referred to herein as a “mobile unit,” a “mobile security unit,” a “mobile surveillance unit,” a “physical unit,” or some variation thereof. According to various embodiments, unit 602 may include one or more sensors (e.g., cameras, weather sensors, motion sensors, noise sensors, chemical sensors, without limitation) 604 and one or more output devices 606 (e.g., lights, speakers, electronic displays, without limitation). For example only, sensors 604 may include one or more cameras, such as thermal cameras, infrared cameras, optical cameras, PTZ cameras, bi-spectrum cameras, any other camera, or any combination thereof. Further, for example only, output devices 606 may include one or more lights (e.g., flood lights, strobe lights (e.g., LED strobe lights), and/or other lights), one or more speakers (e.g., two-way public address (PA) speaker systems), any other suitable output device (e.g., a digital display), or any combination thereof.

In some embodiments, unit 602 may also include one or more storage devices 608. Storage device 608, which may include any suitable storage device (e.g., a memory card, hard drive, a digital video recorder (DVR)/network video recorder (NVR), internal flash media, a network attached storage device, or any other suitable electronic storage device), may be configured for receiving and storing data (e.g., video, images, and/or i-frames) captured by sensors 604. In some embodiments, during operation of unit 602, storage device 608 may continuously record data (e.g., video, images, i-frames, and/or other data) captured by one or more sensors 604 (e.g., cameras, lidar, radar, environmental sensors, acoustic sensors, without limitation) of unit 602 (e.g., 24 hours a day, 7 days a week, or any other schedule).

Unit 602 may further include a computer 610, which may include memory and/or any suitable processor, controller, logic, and/or other processor-based device known in the art. Moreover, although not shown in FIG. 6, unit 602 may include one or more additional devices including, but not limited to, one or more microphones, one or more solar panels, one or more power generators (e.g., fuel cell generators), or any combination thereof. Unit 602 may also include a communication device (e.g., a modem (e.g., a cellular modem, a satellite modem, a Wi-Fi modem, etc.)) 612 that may comprise any suitable and known communication device, which may be coupled to sensors 604, output devices 606, storage device 608, and/or computer 610 via wired connections, wireless connections, or a combination thereof. In some embodiments, communication device 612 may include one or more radios and/or one or more antennas.

System 600 may further include one or more electronic devices 613, which may comprise, for example only, a mobile device (e.g., mobile phone, tablet, etc.), a desktop computer, or any other suitable electronic device including a display. Electronic device 613 may be accessible to one or more end-users. Additionally, system 600 may include a server 616 (e.g., a cloud server or any other server), which may be remote from unit 602. Communication device 612, electronic devices 613, and server 616 may be coupled to one another via the Internet 614.

According to various embodiments of the disclosure, unit 602 may be within a first location (a “camera location” or a “unit location”), and server 616 may be within a second location, remote from the first location. In addition, each electronic device 613 may or may not be remote from unit 602 and/or server 616. As will be appreciated by a person having ordinary skill in the art, system 600 may be modular, expandable, and/or scalable.

As noted above, in some embodiments, unit 602 may include a mobile unit (e.g., a mobile security/surveillance unit). In these and other embodiments, unit 602 may include a portable trailer (not shown in FIG. 6), a storage box (e.g., including one or more batteries) (not shown in FIG. 6), and a mast (not shown in FIG. 6; see e.g., mast 712 in FIG. 7) coupled to a head unit (e.g., including, for example, one or more cameras, one or more lights, one or more speakers, and/or one or more microphones) (not shown in FIG. 6). According to various examples, in addition to sensors and output devices, a head unit of unit 602 may include and/or be coupled to storage device 608, computer 610, and/or communication device 612.

For example, system 600 may include at least a portion of distributed orchestration architecture (e.g., system 300 of FIG. 3). As a more specific example, unit 602 and/or server 616 may include an orchestrator (e.g., orchestrator 302 of FIG. 3), a bus (e.g., bus 304 of FIG. 3), and/or one or more components (e.g., devices 306 of FIG. 3) of an event-driven architecture.

FIG. 7 depicts another example system 700 including a unit 702, in accordance with various embodiments of the disclosure. Unit 702 (e.g., unit 602 of FIG. 6), which may also be referred to herein as a “mobile unit,” a “mobile security unit,” a “live unit,” or a “physical unit,” may be configured to be positioned in an environment (e.g., a parking lot, a roadside location, a construction zone, a concert venue, a sporting venue, a school campus, without limitation). In some embodiments, unit 702 may include one or more sensors (e.g., cameras, weather sensors, motion sensors, noise sensors, without limitation) 704 and one or more output devices 706 (e.g., lights, speakers, electronic displays, without limitation). Unit 702 may also include at least one storage device (e.g., internal flash media, a network attached storage device, or any other suitable electronic storage device), which may be configured for receiving and storing data (e.g., video, images, audio, without limitation) captured by one or more sensors of unit 702. According to some embodiments, unit 702 may be part of at least a portion of a device or system, such as system 300 (see FIG. 3), system 600 (see FIG. 6), system 700 (see FIG. 7), or another device or system.

In some embodiments, unit 702 may include a mobile security unit. In these and other embodiments, unit 702 may include a portable trailer 708, a storage box 710, and a mast 712 coupled to a head unit 714 which may include for example, one or more batteries, one or more cameras, one or more lights, one or more speakers, and/or one or more microphones. According to some embodiments, a first end of mast 712 may be proximate storage box 710 and a second, opposite end of mast 712 may be proximate, and possibly adjacent, head unit 714. More specifically, in some embodiments, head unit 714 may be coupled to mast 712 an end opposite an end of mast 712 proximate storage box 710. According to some non-limiting examples, head unit 714 may include or be a housing that may house and/or may be coupled to various components, such as circuitry, one or more speakers, one or more lights, one or more sensors, and/or one or more batteries, without limitation.

In some examples, unit 702 may include one or more primary batteries (e.g., within storage box 710) and one or more secondary batteries (e.g., within head unit 714). In some embodiments, unit 702 may also include one or more solar panels 716, which may provide power to one or more batteries of unit 702. More specifically, according to some embodiments, one or more solar panels 716 may provide power to a primary battery within storage box 710. Although not illustrated in FIG. 7, unit 702 may also include one or more additional power sources, such as one or more generators (e.g., fuel cell generators), which may or may not be positioned within storage box 710.

As will be appreciated, system 700 may include at least a portion of a distributed orchestration architecture (e.g., system 300 of FIG. 3). As a more specific example, unit 702 and/or an associated server (e.g., cloud server) may include an orchestrator (e.g., orchestrator 302 of FIG. 3), a bus (e.g., bus 304 of FIG. 3), and/or one or more components (e.g., components 306 of FIG. 3) of an event-driven architecture. In one example, one or more devices of unit 702 (e.g., sensors, output devices, input devices, batteries, power sources, communication devices, control devices, and/or other devices) may be and/or include one or more components (e.g., components 306 of FIG. 3) of the event-driven architecture.

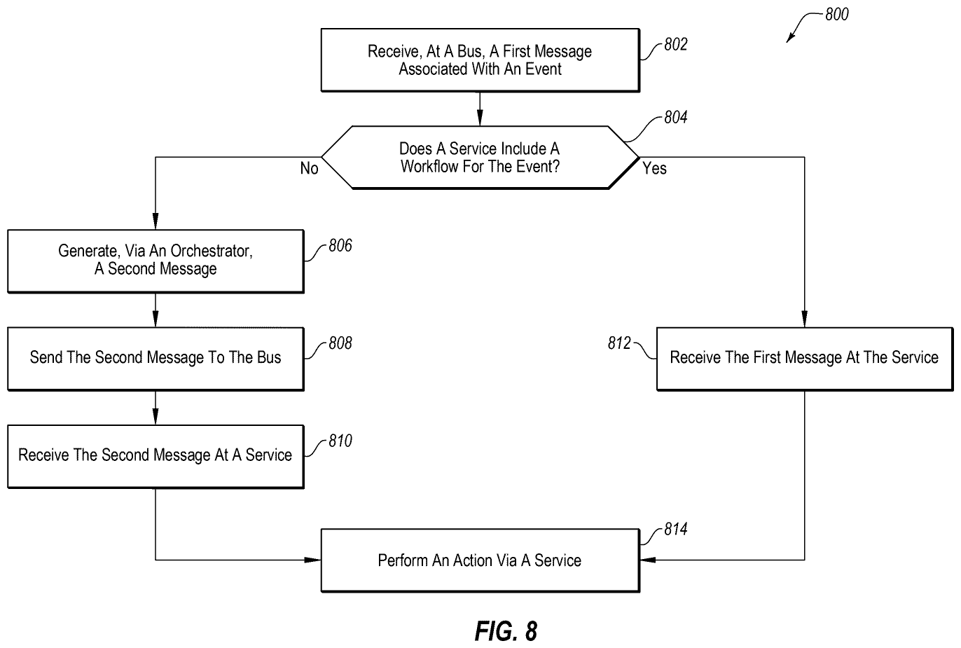

FIG. 8 is a flowchart of an example method 800 of operating an event-driven architecture. Method 800 may be arranged in accordance with at least one embodiment described in the disclosure. Method 800 may be performed, in some embodiments, by a device or system, such as system 300 (see FIG. 3), system 600 (see FIG. 6), system 700 (see FIG. 7), or another device or system. Although illustrated as discrete blocks, various blocks may be divided into additional blocks, combined into fewer blocks, or eliminated, depending on the desired implementation.

Method 800 may begin at block 802, wherein a first message is received at a bus, and method 800 may proceed to block 804. For example, the first message, which is associated with an event (e.g., detection of an object, such as a vehicle, a suspect, an intruder, a trespasser, a loiterer, a suspect with a weapon, etc.), may be generated by a device (e.g., a service or component, such as camera or other sensor) and received at an event bus (e.g., bus 304 of FIG. 3).

At block 804, it may be determined whether a service includes a workflow for the event. More specifically, for example, it may be determined whether a sophisticated service (e.g., of an event-driven architecture) has been assigned a workflow for the event or if an unsophisticated service (e.g., of the event-driven architecture), which is associated with the event, does not include the workflow, and thus an orchestrator (e.g., orchestrator 302 of FIG. 3) includes the workflow (e.g., WF_N). If it is determined that a service includes the workflow, method 800 may proceed from block 804 to block 812. Otherwise, if it is determined that a service does not include the workflow, method 800 may proceed from block 804 to block 806.

At block 806, a second message may be generated via an orchestrator, and method 800 may proceed to block 808. For example, orchestrator 302 (see FIG. 3) may generate the second message. For example, the orchestrator may have performed a workflow for the event prior to the second message being generated. More specifically, for example, in response to the event, the orchestrator may take action (e.g., determine appropriate response to the event based on the workflow) and generate the second message (e.g., a command).

At block 808, the second message may be sent (e.g., published) to the bus, and method 800 may proceed to block 810. For example, orchestrator 302 (see FIG. 3) may send (e.g., publish) the second message to the bus (e.g., bus 304 of FIG. 3). As an example, the second message may include a command (e.g., for a service to take action).

At block 810, the second message may be received by a service, and method 800 may proceed to block 814. For example, a service (e.g., one of components 306 of FIG. 3) may receive the message.

As noted above, with reference to block 804, if it is determined that the service includes the workflow, method 800 may proceed from block 804 to block 812. At block 812, the first message may be received at the service (i.e., the service including the workflow).

At block 814, the service may perform an action. More specifically, for example, in response to either the first message or the second message, a service may perform the action (e.g., based on a workflow). It is noted that the service identified in block 814 may be different depending on which path of method 800 is taken. More specifically, if method 800 proceeds through blocks 806, 808, and 810, the service identified in block 814 is an unsophisticated service. On the other hand, if method 800 proceeds through block 812, the service identified in block 814 is a sophisticated service.

More specifically, in one example wherein a service includes the workflow (i.e., the service is sophisticated), the service, upon receipt of the first message, may perform the workflow to determine a necessary action, and thereafter perform the action (i.e., at block 814) (e.g., determine a spotlight should be turned on and, thereafter turn the spotlight on). In another example wherein the service is unsophisticated, the orchestrator, after performing the workflow (i.e., to determine what action is necessary), may send (e.g., publish) the second message (e.g., a command) to the bus (e.g., at block 808) for the service to receive (i.e., at block 810) and take action (i.e., at block 814).

Modifications, additions, or omissions may be made to method 800 without departing from the scope of the present disclosure. For example, the operations of method 800 may be implemented in differing order. Furthermore, the outlined operations and actions are only provided as examples, and some of the operations and actions may be optional, combined into fewer operations and actions, or expanded into additional operations and actions without detracting from the essence of the disclosed embodiment. For example, method 800 may include determining, for each service of a number of services of the event-driven architecture, whether a service is a sophisticated service or an unsophisticated service. In addition, for example, method 800 may include subscribing, via the orchestrator, to one or more events associated with each service of the number of services determined to be unsophisticated.

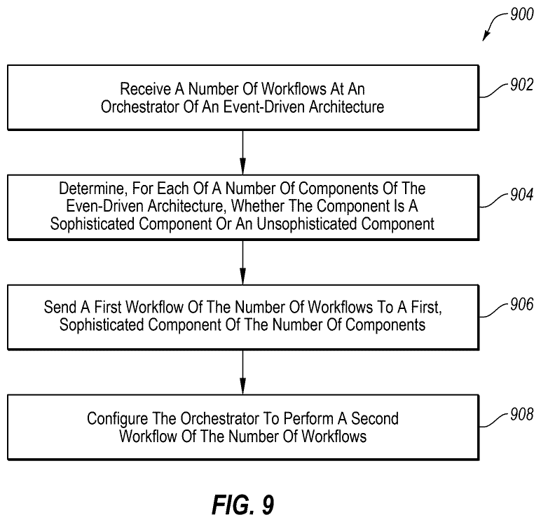

FIG. 9 is a flowchart of an example method 900 of operating an event-driven architecture. Method 900 may be arranged in accordance with at least one embodiment described in the disclosure. Method 900 may be performed, in some embodiments, by a device or system, such as system 300 (see FIG. 3), system 600 (see FIG. 6), system 700 (see FIG. 7), or another device or system. Although illustrated as discrete blocks, various blocks may be divided into additional blocks, combined into fewer blocks, or eliminated, depending on the desired implementation.

Method 900 may begin at block 902, wherein a number of workflows are received at an orchestrator, and method 900 may proceed to block 904. For example, the number of workflows (e.g., generated via workflow tool 308 of FIG. 3) may be received at the orchestrator (e.g., orchestrator 302 of FIG. 3).

At block 904, for each component of a number of components, it may be determined whether the component is a sophisticated component or an unsophisticated component, and method 900 may proceed to block 906. For example, the orchestrator may determine whether each component (e.g., components 306 of FIG. 3) of the event-driven architecture is a sophisticated component (i.e., configured to perform an associated workflow) or an unsophisticated component (e.g., not configured to perform an associated workflow).

At block 906, a first workflow of the number of workflows may be sent to a first, sophisticated component of the number of components. For example, the orchestrator may send the first workflow, which may be associated with a first event, to the first, sophisticated component.

At block 908, the orchestrator may be configured to perform a second workflow of the number of workflows. For example, the second workflow may be associated with a second, different event. In this example, the event-driven architecture may not include a component (i.e., a sophisticated component) configured to perform the second workflow, and thus the orchestrator is configured to perform the second workflow.

Modifications, additions, or omissions may be made to method 900 without departing from the scope of the present disclosure. For example, the operations of method 900 may be implemented in differing order. Furthermore, the outlined operations and actions are only provided as examples, and some of the operations and actions may be optional, combined into fewer operations and actions, or expanded into additional operations and actions without detracting from the essence of the disclosed embodiment. For example, method 900 may include one or more acts wherein the first, sophisticated component performs the first workflow. Further, for example, method 900 may include one or more acts wherein the orchestrator performs the second workflow.

In accordance with common practice, the various features illustrated in the drawings may not be drawn to scale. The illustrations presented in the disclosure are not meant to be actual views of any particular apparatus (e.g., circuit, device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., circuit, device, or system) or all operations of a particular method.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. As used herein, “and/or” includes any and all combinations of one or more of the associated listed items.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

As used herein, the term “substantially” in reference to a given parameter, property, or condition means and includes to a degree that one of ordinary skill in the art would understand that the given parameter, property, or condition is met with a degree of variance, such as within acceptable tolerances. By way of example, depending on the particular parameter, property, or condition that is substantially met, the parameter, property, or condition may be at least 90.0 percent met, at least 95.0 percent met, at least 99.0 percent met, at least 99.9 percent met, or even 100.0 percent met.

As used herein, the term “approximately” or the term “about,” when used in reference to a numerical value for a particular parameter, is inclusive of the numerical value and a degree of variance from the numerical value that one of ordinary skill in the art would understand is within acceptable tolerances for the particular parameter. For example, “about,” in reference to a numerical value, may include additional numerical values within a range of from 90.0 percent to 110.0 percent of the numerical value, such as within a range of from 95.0 percent to 105.0 percent of the numerical value, within a range of from 97.5 percent to 102.5 percent of the numerical value, within a range of from 99.0 percent to 101.0 percent of the numerical value, within a range of from 99.5 percent to 100.5 percent of the numerical value, or within a range of from 99.9 percent to 100.1 percent of the numerical value.

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absent a showing that the terms “first,” “second,” “third,” etc., connote a specific order, these terms should not be understood to connote a specific order. Furthermore, absent a showing that the terms “first,” “second,” “third,” etc., connote a specific number of elements, these terms should not be understood to connote a specific number of elements.

The embodiments of the disclosure described above and illustrated in the accompanying drawings do not limit the scope of the disclosure, which is encompassed by the scope of the appended claims and their legal equivalents. Any equivalent embodiments are within the scope of this disclosure. Indeed, various modifications of the disclosure, in addition to those shown and described herein, such as alternative useful combinations of the elements described, will become apparent to those skilled in the art from the description. Such modifications and embodiments also fall within the scope of the appended claims and equivalents.

What is claimed:

1. A system including an event-driven architecture, the system comprising:
an event bus;
one or more orchestrators communicatively coupled to the event bus; and
a number of components communicatively coupled to the event bus, wherein, in response to a first event, a first component of the number of components is configured to perform a first workflow of a number of workflows;
wherein the one or more orchestrators is configured to:
distribute the first workflow to the first component; and
perform, in response to a second event, a second workflow of the number of workflows.

2. The system of claim 1, wherein the number of components includes at least one camera and at least one light.

3. The system of claim 2, further comprising a mobile surveillance unit including the at least one camera and the at least one light.

4. The system of claim 1, wherein the orchestrator is configured to:
receive a generated workflow;
determine if a component of the number of components is configured to perform the workflow; and
publish the workflow responsive to determining that the component is configured to perform the workflow.

5. The system of claim 4, wherein the component is configured to:
assume the workflow; and
subscribe to at least one event associated with the workflow.

6. The system of claim 1, wherein the orchestrator is configured to:
receive a generated workflow;
determine if at least one component of the number of component is configured to perform the workflow; and
subscribe to at least one event associated with the workflow responsive to determining that the at least one component is not configured to perform the workflow.

7. The system of claim 1, further comprising a workflow generator for generating workflows for the event-driven architecture.

8. The system of claim 1, wherein the orchestrator is configured to:
determine that at least one other component is configured to perform its associated workflow; and
send the associated workflow to the at least one other component responsive to determining that the at least one other component is configured to perform its associated workflow.

9. A system, comprising:
an event bus;
a number of components communicatively coupled to the event bus, wherein:
a first component of the number of the components is a sophisticated component configured to perform a first workflow; and
a second component of the number of components is an unsophisticated component; and
an orchestrator communicatively coupled to the event bus and configured to distribute a workflow to the first component.

10. The system of claim 9, wherein the number of components includes at least one sensor and at least one output device.

11. The system of claim 10, further comprising a mobile surveillance unit including the at least one sensor and at least one output device.

12. The system of claim 9, wherein the orchestrator is further configured to:
determine, for each component of the number of components, whether the component is sophisticated or unsophisticated;
publish an associated workflow to the event bus responsive to determining that the component is sophisticated; and
subscribe to at least one event associated with the associated workflow responsive to determining that the component is unsophisticated.

13. The system of claim 9, wherein the first component is configured to subscribe to at least one event associated with the first workflow.

14. The system of claim 9, further comprising a workflow generator communicatively coupled to the orchestrator and configured to generate a number of workflows.

15. The system of claim 9, further comprising a mobile unit including at least one component of the number of components.

16. A method of operating an event-driven architecture, the method comprising:
receiving, at a bus of the event-driven architecture, a first message associated with an event;
responsive to determining that a service of a number of services does not include a workflow for the event:
generating, via an orchestrator, a second message;
publishing the second message to the bus; and
receiving, via the service, the second message;
receiving, via the service, the first message responsive to determining that the service includes the workflow for the event; and
performing an action via the service.

17. The method of claim 16, further comprising determining if the service includes the workflow for the event.

18. The method of claim 16, further comprising determining, for each service of a number of services of the event-driven architecture, whether a service is a sophisticated service or an unsophisticated service.

19. The method of claim 18, further comprising subscribing, via the orchestrator, to one or more events associated with each service of the number of services determined to be unsophisticated.

20. The method of claim 16, further comprising:
generating the workflow;
publishing the workflow to the orchestrator;
determining if a service of the number of services is configured to perform the workflow;
publishing the workflow to the bus responsive to determining that the service is configured to perform the workflow; and
subscribe to at least one event associated with the workflow responsive to determining that the service is not configured to perform the workflow.

21. An event-driven architecture, comprising:
an event bus;
an orchestrator communicatively coupled to the event bus; and
a number of components communicatively coupled to the event bus;
wherein responsive to a first event, a first component of the number of components performs a first workflow;
wherein, responsive to a second, different event, the orchestrator performs a second workflow.

22. The event-driven architecture of claim 21, wherein the first component is a sophisticated component, and a second component that is associated with the second, different event is an unsophisticated component.

23. A method of operating an event-driven architecture, the method comprising:
receiving a number of workflows at an orchestrator of the event-driven architecture;
determining, for each of a number of components of the event-driven architecture, whether the component is a sophisticated component or an unsophisticated component; and
sending a first workflow of the number of workflows to a first, sophisticated component of the number of components.

24. The method of claim 23, further comprising performing the first workflow via the first sophisticated component.

25. The method of claim 23, further comprising performing a second workflow of the number of workflows via the orchestrator.
